(19) United States
(12) Patent Application Publication
(10) Pub. No.: US 2011/0142116 A1
(43) Pub. Date: Jun. 16, 2011

(54) METHOD AND APPARATUS FOR ESTIMATING CHANNEL PARAMETER

(75) Inventors: Jae-Joon Park, Daejeon-si (KR); Myung-Don Kim, Daejeon-si (KR); Hyun-Kyu Chung, Daejeon-si (KR)

(73) Assignee: Electronics and Telecommunications Research Institute, Daejeon-si (KR)

(21) Appl. No.: 12/846,288

(22) Filed: Jul. 29, 2010

(30) Foreign Application Priority Data
Dec. 15, 2009 (KR) 10-2009-0124767
Mar. 18, 2010 (KR) 10-2010-0024438

(51) Int. Cl. H04B 17/00; H04B 3/46

(52) U.S. Cl. 375/227; 375/224

(57) ABSTRACT

A method and apparatus for estimating a channel parameter in a multi-antenna system is provided. The method of estimating a channel parameter includes selecting at least a part of received data as an effective segment based on power of the received data, and estimating a channel parameter by applying a channel estimation algorithm to received data within the selected effective segment. Accordingly, it is possible to reduce the amount of calculation by removing noise signals from received data and measuring channels using signals within an effective signal segment when the channel parameters are estimated.

### CROSS-REFERENCE TO RELATED APPLICATION

This application claims the benefit under 35 U.S.C. §119(a) of Korean Patent Application Nos. 10-2009-0124767, filed on Dec. 15, 2009, and 10-2010-0024438, filed on Mar. 18, 2010, the entire disclosures of which are incorporated herein by references for all purposes.

### BACKGROUND

1. Field

The following description relates to a method and apparatus for estimating channel parameters in a multi-antenna system.

2. Description of the Related Art

Multiple-input and multiple-output (MIMO) technology has attracted attention in a next-generation communication system and has thus been actively researched. In association with the MIMO technology, research on a channel model has been carried out. Evaluation and analysis of a channel model from a measured channel may be helpful in understanding radio wave propagation characteristics and may ultimately lead to implementation of an efficient wireless communication system.

Wireless spatial channel parameters include multi-path delay, angle of arrival (AoA), angle of departure (AoD), Doppler frequency, and complex channel amplitude. Various estimation methods and channel models have been presented to estimate the parameters.

Space-Alternating Generalized EM (SAGE) algorithm is typically employed to analyze the wireless spatial channel parameters. The SAGE algorithm refers to iteration-based channel estimation which iteratively estimates channel parameters using received data samples.

In this case, due to increases in iteration times, the number of multiple paths and the number of channel parameters, the amount of calculation may be substantially increased accordingly.

### SUMMARY

The following description relates to a method and apparatus for estimating a channel parameter, capable of reducing the amount of calculation of an estimation algorithm and increasing the accuracy.

In one general aspect, there is provided a method of estimating a channel parameter, including: selecting at least a part of received data as an effective segment based on power of the received data; and estimating a channel parameter by applying a channel estimation algorithm to is received data within the selected effective segment.

Selecting the at least a part of received data as an effective segment may include determining noise power of a noise signal included in the received data, determining effective signal power from the noise power, and selecting a segment with a power of the effective signal power or greater as an effective segment.

In another general aspect, there is provided a channel parameter estimator including: a data receiving unit receiving data; a signal selecting unit selecting at least a part of the received data as an effective segment based on received power of the received data; and a parameter estimating unit estimating a channel parameter by applying a channel estimation algorithm to the received data within the selected effective segment.

The signal selecting unit may include a noise power determining unit determining noise power of a noise signal included in the received data, and a signal power determining unit determining effective signal power from the noise power, wherein the signal selecting unit selects a segment of the received data with a power of the effective signal power or greater as an effective segment.

The parameter estimating unit may estimate a channel parameter by applying a channel estimation algorithm to received data within the effective segment, determine at least a part of the received data within the effective segment as a multi-path segment based on the estimated channel parameter, and estimate a channel parameter by applying a channel estimation algorithm to received data within the multi-path segment.

Other features and aspects will be apparent from the following detailed description, the drawings, and the claims.

### BRIEF DESCRIPTION OF THE DRAWINGS

FIG. 1 is a diagram illustrating an example of a wireless spatial channel measurement system according to an exemplary embodiment of the present invention.

FIG. 2 is a flowchart illustrating a typical method of estimating channel parameters.

FIG. 3 is a block diagram illustrating an example of a channel parameter estimator according to an exemplary embodiment of the present invention.

FIG. 4 is a graph illustrating power delay profile of received data according to an exemplary embodiment of the present invention.

FIG. 5 is a flowchart illustrating an example method of estimating channel parameters according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

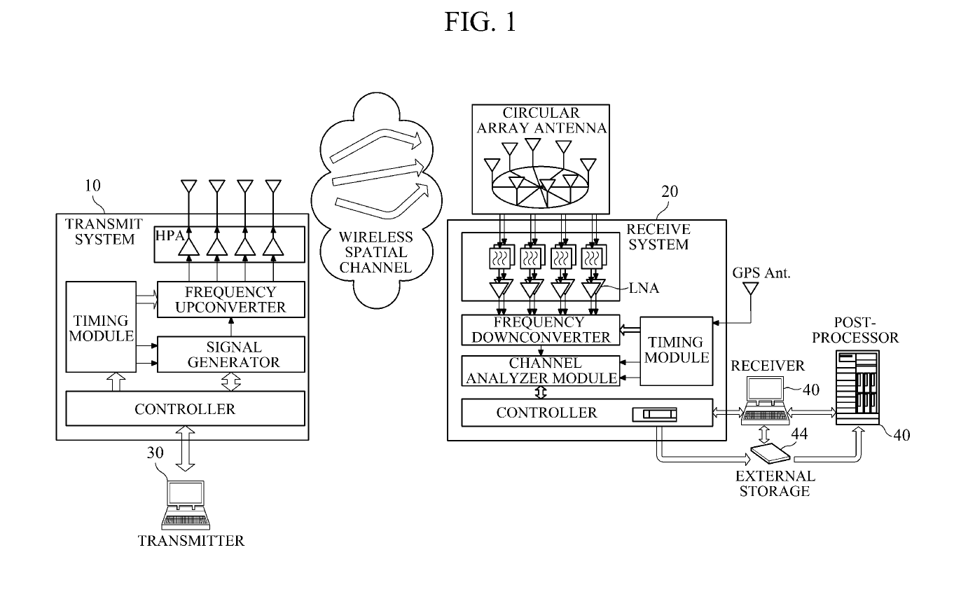

FIG. 1 is a diagram illustrating an example of a wireless spatial channel measurement system according to an exemplary embodiment of the present invention.

Referring to FIG. 1, in a multiple-input and multiple-output (MIMO) communication is system, a transmitter 30 and a receiver 40 perform data communication through a transmit system 10 and a receive system 20 using multiple array antennas.

A wireless spatial channel measurement system may transmit or receive signals in a sequential manner through multiple antennas so that MIMO channel measurement may be performed. The broadband MIMO channel measurement system includes the transmit system 10 transmitting a pseudo noise (PN) signal at a rate of up to 100 Mcps, and the receive system 20.

The receiver 40 is designed such that a measurement signal is loaded by an external control PC. The receiver 40 stores wireless spatial channel measurement data in an external storage 44. A post-processor 42 is used to analyze characteristics of a wireless spatial channel through a channel characteristic process, a channel modeling process, and a received complex data process.

Examples of the characteristics of the channel may include impulse response, scattering function, power delay profile (PDP), and Doppler power spectrum.

A signal generator of the transmit system 10 generates a signal at the data request of the transmitter 30. The signal generated by the signal generator is converted into an analog signal by a D/A converter. The analog signal is converted into an RF signal by a low-pass filter (LPF) and a frequency upconverter and is transmitted in a time-division manner to multiple antennas through a power amplifier. The transmit system 10 uses a clock generated by a 10 MHz rubidium oscillator to enhance precision.

The receive system 20 receives a signal selected in a time-division manner through multiple circular array antennas. The selected RF signal is input to a high-speed A/D converter through a low-noise amplifier (LNA) and a frequency downconverter. The high-speed A/D converter converts the analog signal into a digital signal and transmits it to a channel analyzer module. The channel analyzer module analyzes the channel characteristics using data acquired from the high-speed A/D converter.

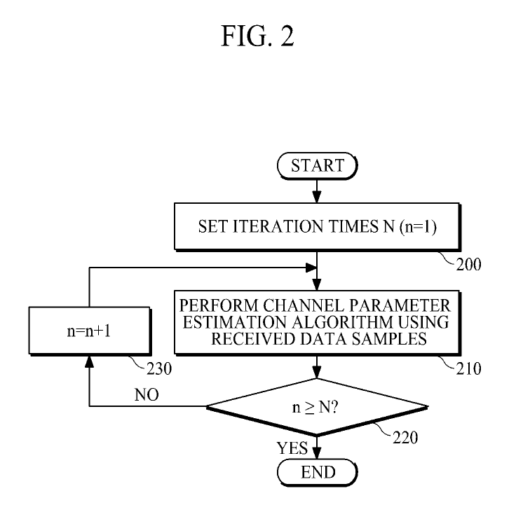

FIG. 2 is a flowchart illustrating a typical method of estimating channel parameters.

In operation 200, the iteration times N of a channel estimation algorithm and the number of multiple paths M are set to estimate channel parameters. In operations 210, 220 and 230, the channel estimation algorithm is performed the iteration times N on received sample data.

The channel estimation algorithm may be, but is not limited to, a space-alternating generalized EM (SAGE) algorithm. The SAGE algorithm is iteratively performed to estimate a parameter with elements except one of them to be estimated among the elements τ, Φ, ν and α of a parameter θ. The channel estimation using the SAGE algorithm is advantageous in that it is very fast and accurate.

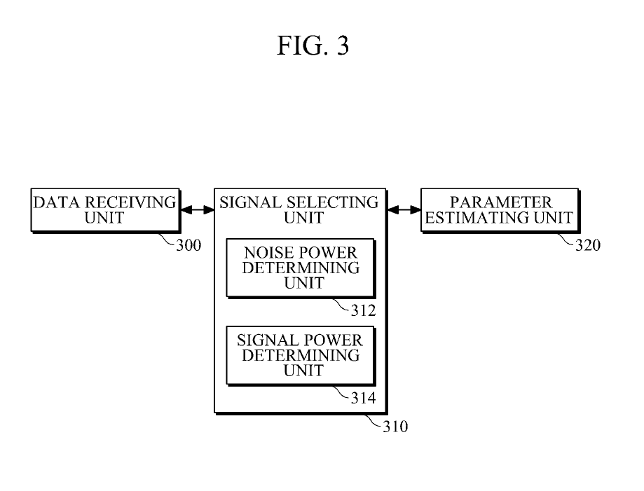

FIG. 3 is a block diagram illustrating an example of a channel parameter estimator according to an exemplary embodiment of the present invention.

Referring to FIG. 3, the channel parameter estimator includes a data receiving unit 300, a signal selecting unit 310 and a parameter estimating unit 320.

The data receiving unit 300 receives data selected in a time-division manner through multiple circular array antennas. In one embodiment, the received data may be a pseudo noise sequence. The pseudo noise sequence may be large enough for a noise signal segment to be easily recognized on power delay profile of data recognized through correlation.

The signal selecting unit 310 and the parameter estimating unit 320 may be implemented by a microprocessor and a program stored and driven therein.

The signal selecting unit 310 selects at least a part of the received data as an effective segment based on received power of the data received by the data receiving unit 300. The signal is selecting unit 310 includes a noise power determining unit 312 and a signal power determining unit 314.

The noise power determining unit 312 determines noise power of a noise signal included in the received data. In one embodiment, the noise power determining unit 312 measures power of data received after a predetermined time and determines the average of the measured power as noise power. The signal power determining unit 314 determines effective signal power from the noise power determined by the noise power determining unit 312. In one embodiment, the signal power determining unit 314 determines effective signal power using the average and standard deviation of the noise power. The signal power determining unit 314 selects a segment with the calculated effective signal power or greater as an effective segment.

The parameter estimating unit 320 estimates a channel parameter by applying a channel estimation algorithm to the effective segment determined by the signal selecting unit 310.

In one embodiment, the parameter estimating unit 320 estimates a channel parameter by applying a channel estimation algorithm to received data within the effective segment. Based on the estimated channel parameter, the parameter estimating unit 320 sets at least a part of the received data within the effective segment as a multi-path segment. In this case, at least a part of the received data within the effective segment may be determined as a multi-path segment by adding or subtracting a predetermined constant value to or from a delay set on each of multiple paths estimated based on the estimated channel parameter. The channel parameter is estimated by applying the channel estimation algorithm to the received data within the multi-path segment.

The parameter estimating unit 320 determines the iteration times of the channel estimation algorithm for the received data within the effective segment and the iteration times of the channel estimation algorithm for the received data within the multi-path segment. The channel estimation algorithm for the received data within the effective segment is performed the iteration times of the channel estimation algorithm for the received data within the effective segment. On the other hand, the channel estimation algorithm for the received data within the multi-path segment is performed the iteration times of the channel estimation algorithm for the received data within the multi-path segment. In this case, the iteration times of the channel estimation algorithm for the received data within the effective segment may be equal to, but is not limited to, the iteration times of the channel estimation algorithm for the received data within the multi-path segment.

In another embodiment, the parameter estimating unit 320 may perform interpolation on the received data. More specifically, the interpolation may be performed for the estimation of a certain value between two variables or more. Further, oversampling may be performed to enhance the accuracy of parameter estimation for the received data.

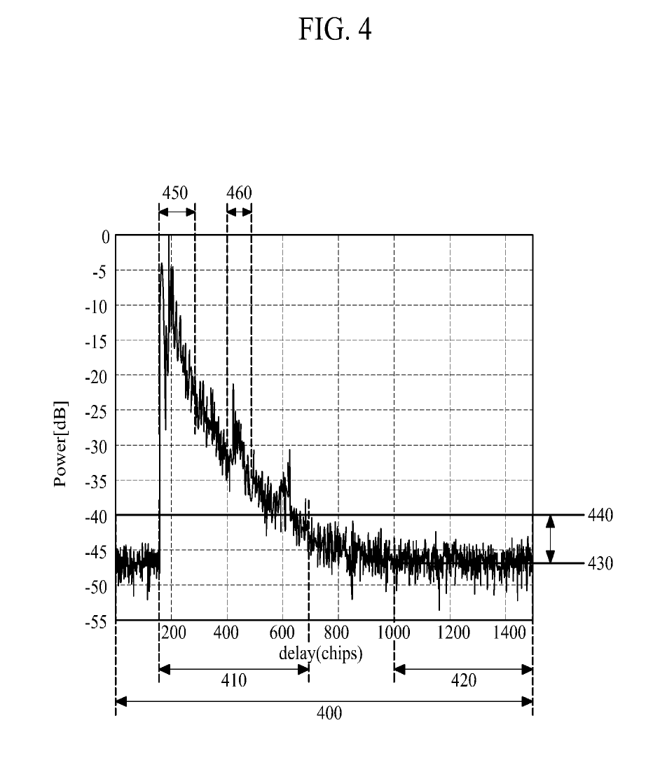

FIG. 4 is a graph illustrating power delay profile of received data according to an exemplary embodiment of the present invention.

Referring to FIG. 4, the graph illustrates power delay profile (PDP) and received signal power using pseudo noise code as a result of correlation between received PN code and original PN code.

Referring to FIG. 4, noise power 430 is estimated from signals within a noise region 420 of received data. Effective signal power 440 is estimated using the estimated noise power.

Conventional parameter estimation uses data samples within the whole region 400 to estimate parameters. In mobile communications, since a base station generally has a radius of coverage of about 1 km, only a noise exists about 20 msec after a receiver receives data from a transmitter. Hence, the average and standard deviation of noise signal power may be obtained using a long PN code and representative power of the noise signal may thus be obtained.

The effective segment 410 is set using the estimated effective signal power 440 and the received data. The channel parameter is estimated according to a conventional channel estimation method using the received data samples within the effective segment 410.

A multi-path segment 460 is set using the estimated channel parameter. According to an embodiment of the present invention, a parameter estimation technology is provided which is capable of reducing a calculation process and improving accuracy by further performing a channel parameter estimation algorithm using received data samples corresponding to a multi-path segment to obtain a final result.

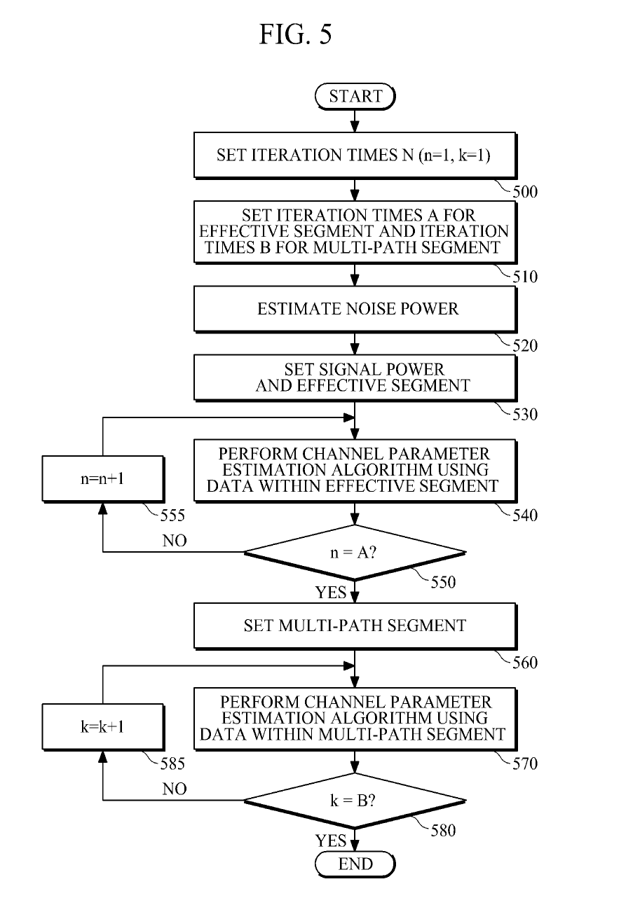

FIG. 5 is a flowchart illustrating an example method of estimating channel parameters according to an exemplary embodiment of the present invention.

In operation 500, the iteration times N of a channel estimation algorithm is determined in a manner similar to a conventional channel parameter estimation method. The iteration times N is set to be large enough to improve the accuracy of parameter estimation. In operation 510, the iteration times A of the channel estimation algorithm for received data within an effective segment and the iteration times B of the channel estimation algorithm for received data within a multi-path segment are set such that the sum of the iteration times A and B is equal to the iteration times N. The iteration times A and the iteration times B may be, but is not limited to, the same.

In operation 520, noise power is estimated. The noise power may be estimated by measuring power of data received a predetermined time after the data begins to be received and obtaining the average of the power.

In operation 530, effective signal power and effective segment are determined from the noise power. In one embodiment, the effective signal power may be determined using the average and standard deviation of the noise power. A segment with a power of the obtained effective signal power or greater is selected as an effective segment.

In operation 540, the channel parameter estimation algorithm is performed using data within the selected effective segments. In operations 550 and 555, the channel parameter estimation algorithm is iteratively performed the iteration times A.

In operation 560, a multi-path segment is set. Based on the channel parameter estimated for the received data within the effective segment, at least a part of a segment may be set to a multi-path segment. For example, at least a part of the effective segment may be selected as a multi-path segment by adding or subtracting a predetermined constant value to or from a delay which is set on each of multiple paths estimated based on an estimated channel parameter.

In operation 570, the channel parameter estimation algorithm is performed using data within the selected multi-path segment. In operations 580 and 585, the channel parameter estimation algorithm is iteratively performed the iteration times B.

As apparent from the above description, in order to extract multi-path channel parameters from measured data, noise signals are removed from received data and channels are measured using signals within an effective signal segment when the channel parameters are estimated, thereby reducing the amount of calculation. On the other hand, for a region where a signal is present, the number of data samples is increased, thereby further improving the accuracy of channel parameter estimation.

The current embodiments can be implemented as computer readable code in a computer readable recording medium. Code and code segments constituting the computer program can be easily inferred by a skilled computer programmer in the art. The computer readable recording medium includes all types of recording media in which computer readable data are stored. Examples of the computer readable recording medium include a ROM, a RAM, a CD-ROM, a is magnetic tape, a floppy disk, and an optical data storage. Further, the recording medium may be implemented in the form of a carrier wave such as Internet transmission. In addition, the computer readable recording medium may be distributed to computer systems over a network, in which computer readable code may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of estimating a channel parameter, comprising:
selecting at least a part of received data as an effective segment based on power of the received data; and
estimating a channel parameter by applying a channel estimation algorithm to received data within the selected effective segment.

2. The method of claim 1, wherein selecting the at least a part of received data as an to effective segment comprises:
determining noise power of a noise signal included in the received data;
determining effective signal power from the noise power; and
selecting a segment with a power of the effective signal power or greater as an effective segment.

3. The method of claim 2, wherein estimating the channel parameter comprises:
determining at least a part of the received data within the effective segment as a multi-path segment based on the estimated channel parameter; and
estimating the channel parameter by applying a channel estimation algorithm to received data within the multi-path segment.

4. The method of claim 3, further comprising determining iteration times of the channel estimation algorithm for the received data within the effective segment and iteration times of the channel estimation algorithm for the received data within the multi-path segment.

5. The method of claim 2, determining the effective signal power comprises determining the effective signal power using average and standard deviation of the noise power.

6. The method of claim 2, determining the noise power comprises:
measuring power of data received after a predetermined time; and
determining average of the measured power as noise power.

7. The method of claim 1, wherein the received data is a pseudo noise sequence.

8. A channel parameter estimator comprising:
a data receiving unit receiving data;
a signal selecting unit selecting at least a part of the received data as an effective segment based on received power of the received data; and
is a parameter estimating unit estimating a channel parameter by applying a channel estimation algorithm to the received data within the selected effective segment.

9. The channel parameter estimator of claim 8, wherein the signal selecting unit comprises:
a noise power determining unit determining noise power of a noise signal included in the received data; and
a signal power determining unit determining effective signal power from the noise power,
wherein the signal selecting unit selects a segment of the received data with a power of the effective signal power or greater as an effective segment.

10. The channel parameter estimator of claim 9, wherein the parameter estimating unit estimates a channel parameter by applying a channel estimation algorithm to received data within the effective segment, determines at least a part of the received data within the effective segment as a multi-path segment based on the estimated channel parameter, and estimates a channel parameter by applying a channel estimation algorithm to received data within the multi-path segment.

11. The channel parameter estimator of claim 10, wherein the parameter estimating unit determines iteration times of the channel estimation algorithm for the received data within the effective segment and iteration times of the channel estimation algorithm for the received data within the multi-path segment.

12. The channel parameter estimator of claim 9, wherein the noise power determining unit determines the effective signal power using average and standard deviation of the noise power.

13. The channel parameter estimator of claim 9, wherein the noise power determining unit measures power of data received after a predetermined time and determines average of the measured power as noise power.

14. The channel parameter estimator of claim 8, wherein the received data is a pseudo noise sequence.

15. The channel parameter estimator of claim 10, wherein the parameter estimating unit adds or subtracts a predetermined constant value to or from a delay set on each of multiple paths estimated based on the estimated channel parameter to determine at least a part of the received data within the effective segment as a multi-path segment.

16. The channel parameter estimator of claim 8, wherein the parameter estimating unit performs interpolation on the received data within the effective segment selected by the signal selecting unit.

17. The channel parameter estimator of claim 8, wherein the parameter estimating unit performs oversampling on the received data within the effective segment selected by the signal is selecting unit.
